(19) United States
(12) Patent Application Publication
(10) Pub. No.: US 2020/0197919 A1
(43) Pub. Date: Jun. 25, 2020

(54) Catalyst Formulations with Improved Performance via Variable Composition Control as a Function of Particle Size

(71) Applicant: Quanta Technologies, LLC, Houston, TX (US)

(72) Inventor: Augusto Rodolfo Quinones, Houston, TX (US)

(73) Assignee: Quanta Technologies, LLC, Houston, TX (US)

(21) Appl. No.: 16/776,613

(22) Filed: Jan. 30, 2020

Related U.S. Application Data
(63) Continuation of application No. 13/071,864, filed on Mar. 25, 2011, now abandoned.
(60) Provisional application No. 61/340,898, filed on Mar. 25, 2010.

(51) Int. Cl. B01J 37/00; C10G 11/02; C10G 11/18; B01J 29/80; B01J 29/40; B01J 35/00; B01J 35/02

(52) U.S. Cl. CPC B01J 37/0045; C10G 11/02; C10G 11/18; B01J 29/80; B01J 29/084; B01J 29/40; B01J 35/0006; B01J 35/023; B01J 37/009

(57) ABSTRACT

This invention provides for a method of making a spray-dried catalyst composition for use in any hydrocarbon conversion process. The particle size of the components is adjusted to improve the functionality of the catalyst for specific reactions. This invention also provides for a composite catalyst composition for use in any hydrocarbon conversion process that is dependent on the particle size.

### CROSS-REFERENCE TO RELATED APPLICATIONS

This Application claims the benefit of U.S. Provisional Application No. 61/340,898 filed Mar. 25, 2010 which is hereby incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

Fluid catalytic cracking (FCC) is an important process for the upgrading of the heavy end of petroleum to liquid fuels or valuable petrochemicals. As the nature of the feedstocks and desired products varies widely depending on crude availability and/or market conditions, the makers of the catalyst used in those units routinely make custom formulations to address specific needs of the refiner. For example, for processing heavy feedstocks, the FCC catalyst formulation may include elements that passivate the detrimental effects of Nickel and Vanadium. Also, a very active alumina matrix may be included to improve the conversion of the heaviest part of the feedstock as the zeolite may not be able to effectively crack very large molecules.

Another application that has gained importance in the FCC industry is the use of ZSM-5 or similar zeolites as part of the formulation either as an integral part of the catalyst or as a secondary additive. ZSM-5 is generally accepted to crack primary olefinic products into smaller hydrocarbon molecules. ZSM-5 was initially used to increase octane which it does either by aromatic concentration alone or in combination with the addition of alkylate product from the C3 and C4 olefins whose production is enhanced with its use.

FCC catalysts are usually made by spray drying slurries that contain a mixture of the desired components that usually include zeolite Y, clay, alumina and a binder which can be based on silica sols, alumina sols or mixtures of both. In one particular technology, a highly peptizable alumina itself becomes the primary binder. In another technology known as “in-situ” technology by the industry, a particle containing clay treated at specific conditions is formed via spray drying and then it is processed to grow zeolite Y. Sometimes, other components like Silica or Alumina or both can be added to the clay for specific properties.

In all cases, the slurry is spray-dried to give a more or less spherical shaped particle. The particle size distribution of the spray-dried material is a function of the spray drier conditions and the slurry. In general, the desired properties include: (1) a minimal amount of the 0-20 micron particles, (2) 10-20% of the particles between 20-40 microns, and (3) an average particle size distribution between 65 microns and 85 microns. In general, FCC catalysts are made as a continuum of particle sizes and compositions determined by the slurry properties and the spray drier conditions. In some cases, an air classifier is used to remove the smaller particles to meet customer specifications. In general, the 0-40 micron content can be controlled by the use of air classifiers, but this practice is costly as the efficiency of the classifiers is poor and valuable product is lost in order to meet a specification.

The chemical reactions that occur in the FCC process can be diffusion limited. In general these reactions are defined as reactions in which mass transport of reactants into the catalyst particle limits the reaction efficiency. In commercial processes, many reactions occur and some of them may be diffusion limited while others are not. Another useful way to define such reactions is to indicate that the amount of reaction or their yields are dependent on the particle size of the solid catalyst. These conditions of “diffusion limitation” are also common to many other catalytic processes. For example, Nickel containing hydrocarbons are very large and react primarily on the outer-most layers of the FCC catalyst particle. This results in most of the Nickel being deposited on the outside of the particle. A simple analysis of the total external area of the particles as a function of the radius of the particles shows that Nickel will be preferentially deposited on the smaller particles due to a larger external area per unit of volume. Other important hydrocarbon conversion processes in which mass transfer is key is in solid-liquid/solid-solid reactions like those for Biomass conversion of wood or cellulosic material in contact with a solid catalyst particle. Furthermore, other reactions in which the contact time is very short tend to also fall in the definition of diffusion limited reactions.

Just as Nickel deposition on the FCC catalyst particle is a function of particle size, many other reactions, some desirable, some undesirable, are dependent on the particle size of the FCC catalyst.

In general, the catalyst composition of an FCC catalyst is the same across particle sizes. When mixtures of additives are included, these additives may have a slightly different particle size distribution. However, it is a clear characteristic of all FCC catalysts and additives used to date, to have a continuous, smooth particle size distribution.

While interpreting the terms used in this patent application one must consider the different techniques to measure the particle size distribution. When we speak of particle size distribution, we refer to the actual physical size as measured by physical methods (like a screen) in which minimizing agglomeration or attrition, fractions are measured by whether or not particles are able to go through the screen without major external forces with the exception of gravity and vibratory motion. In the case of light scattering methodologies, which are well-known to a person in the art, the particle size distributions are continuous by mathematical manipulations of the experiments. Such continuum is an approximation and it is a limitation of this technique.

### BRIEF SUMMARY OF THE INVENTION

This invention provides for a method of making a spray-dried catalyst composition for use in any hydrocarbon conversion process including removing more than 90% of particles above a specified threshold and reprocessing the removed particles for re-use in the same or another hydrocarbon conversion process. The removed particles can be reduced in particle size. The spray-dried catalyst composition can be a fresh composition, an equilibrium composition, or a combination of fresh catalyst and equilibrium catalyst.

The particles in the catalyst composition that are larger than the specified threshold can be removed by air classification, screening, or by a combination of air classification and screening. The specified threshold can be 110 microns, 100 microns, 90 microns, 80 microns, 70 microns, 60 microns, 50 microns, 40 microns, 30 microns, or 20 microns. The method can also include using a metal trap to passivate Nickel and Vanadium. The hydrocarbon conversion process can depend on particle size for reaction rate or yields.

This invention also provides for a composite catalyst composition for use in any hydrocarbon conversion process that is dependent on the particle size. The composite catalyst can be formed by blending of two or more components with different compositions and different particle size distribution, and at least one of the components can contain a limitation on the particle size. The composite catalyst can be limited so that no more than 5% of the particles are larger than 110 microns and no more than 5% of the particles are smaller than 20 microns. One of the components of the composite catalyst can contain ZSM-5 or other MFI zeolite. The components may be separated into two or more fractions with different chemical compositions for possible reuse.

The invention also provides for a composite catalyst composition formulated for a specific hydrocarbon conversion process by size distribution. The composite catalyst can have a high amount of matrix activity and a standard FCC catalyst for bottoms conversion. The composite catalyst for use with bottoms conversion can have a low zeolite to matrix composition with more than 95% of its particles less than 80 microns and up to 50% of a ZSM-5 additive with optimized particle size distribution.

### DETAILED DESCRIPTION OF THE INVENTION

Many reactions are dependent on the particle size of the FCC catalyst. This invention provides for building an FCC catalyst system in which the particle size of different components is adjusted to improve the activity and selectivity of specific reactions. One key element is that the particle size of the fractions does not overlap with that of other components in at least one particle size range. In the present invention, at least one of the components of the catalyst will be characterized by having a particle size distribution that does not overlap by more than 50% with the particle size of the other components. This region where the two compositions of matter do not overlap is a key characteristic of the overall system as it would allow for a more effective separation of the individual components after use. Another element is that the composite catalyst will have no more than 5% of the particles larger than 110 microns and no more than 5% of the particles smaller than 20 microns. In another application of the technology described in this patent, after usage, the FCC catalyst can be recycled for reuse.

One application of the present invention is the use of high matrix components for improved bottoms cracking. Cracking of large molecules is also a diffusion limited reaction. I have found that a catalyst composition in which the bottoms upgrading components are preferentially situated in the small particle size range is intrinsically better than with a homogeneous composition. The composite catalyst formulated by size distribution with a high amount of matrix activity and a standard FCC catalyst in this invention has improved bottoms upgrading and improved coke selectivity versus a standard catalyst with standard particle size distribution. Bottoms conversion is preferentially performed by matrix components.

High C3=(propylene) systems contain mixtures of FCC catalysts and large amounts of ZSM-5 based additives. C3=yield is known in the art to be the least dependent yield as a function of particle size. It appears in some cases that C3=can be increased by using large particles containing ZSM-5. State-of-the-art high propylene systems are defined as those in which the ZSM-5 additive is added to a base catalyst with similar particle size distribution or one in which the ZSM-5 additive has a larger particle size distribution than the typical FCC catalyst. In this invention, the FCC catalyst is modified to reduce its particle size. The smaller particles of the catalyst will generate a higher amount of light olefins in gasoline. It is accepted by those skilled in the art that the effectiveness of ZSM-5 is enhanced by a higher concentration of light olefins in the light naphtha where ZSM-5 operates. Thus, a catalyst composition in which the FCC catalyst has a substantially smaller particle size than a typical FCC catalyst would present a much higher effectiveness than current standard systems. A particular system for C3=maximization includes: (1) a low zeolite to matrix catalyst composition with more than 95% of its particles less than 80 microns to maximize bottoms upgrading and gasoline olefin concentration; and (2) up to 50% of a ZSM-5 additive with optimized particle size distribution.

Another application of the present invention is the use of metal traps. In this application the size of the metal traps will also be substantially smaller than those of the host catalyst enhancing the capability to capture and/or passivate the undesired Nickel and Vanadium species.

In this invention, we claim a catalyst composition with improved catalytic behavior by controlling the composition of the catalyst as a function of particle size or by severely restricting the size of particle sizes in the catalyst compositions to levels that substantially differ from current state-of-the-art catalysts. In particular, we will:
a) Limit the overall size of the catalyst particles to being much smaller than current state-of-the art catalysts. For example, in one preferred application, we will limit the amount of particles with a particle size greater than 100 microns. This could be done by air classification, screening, a combination of both or by selective milling of particles larger than the threshold.
b) Control the composition of the catalyst in the smaller range to favor desired yields for reactions that we believe are diffusion limited. For example, while in current state-of-the-art formulations ZSM-5 additives are used for the improvement of LPG olefins, the composition of the ZSM-5 additive is either similar or larger than the base cracking catalyst. In one of the applications of this invention, we will make the ZSM-5 additive substantially smaller in size than the host catalyst. This will make the effectiveness of the ZSM-5 additive higher as many desired reactions and yields are diffusion limited.
   Definition of terms used:

“Fluid Catalytic Cracking” or “FCC”—a process in which a hydrocarbon feed, at least ten (10) volume percent of which boils at a temperature above six hundred fifty degrees Fahrenheit (650° F.), is catalytically converted in the absence of added hydrogen to lower boiling products by contact with a circulating inventory of catalyst consisting of finely divided solid catalyst particles having an average surface-volume particle size ranging from about twenty (20) to one hundred twenty (120) microns at temperatures in excess of five hundred degrees Fahrenheit (500° F.), in which process (1) the conversion and catalyst regeneration proceed in separate zones with transfer of catalyst between zones and (2) the catalyst is present in the reaction zone in the form of a fluid mass dispersed in the hydrocarbon vapors undergoing conversion.

“Specified threshold”—a specific threshold level for the size of the particles such as 110 microns, 100 microns, etc.

“Reprocessing”—can mean sorting by particle size.

“Equilibrium composition” or “equilibrium catalyst”—a spray-dried catalyst composition which has already been used in a hydrocarbon conversion process and that has been removed from such unit for reuse or disposal.

“Metal trap”—an additive used to remove metal from the hydrocarbon whereby the metal is chemically attracted to the additive.

“A high amount of matrix activity”—a catalyst having a high percent of its total surface area in the mesopore range.

Various changes could be made in the above construction and method without departing from the scope of the invention as defined in the claims below. It is intended that all matter contained in the paragraphs above, as shown in the accompanying drawings, shall be interpreted as illustrative and not as a limitation.

I claim:

1. A method of making a spray-dried catalyst composition for use in any hydrocarbon conversion process comprising:
(a) removing more than 90% of particles above a specified threshold; and
(b) reprocessing the removed particles for re-use in the same or another hydrocarbon conversion process.

2. The method of claim 1 wherein the removed particles are reduced in particle size.

3. The method of claim 1 wherein the spray-dried catalyst composition is a fresh composition.

4. The method of claim 1 wherein the spray-dried catalyst composition is an equilibrium composition.

5. The method of claim 1 wherein the spray-dried catalyst composition is a combination of fresh catalyst and equilibrium catalyst.

6. The method of claim 1 wherein the particles larger than the specified threshold are removed by air classification.

7. The method of claim 1 wherein the particles larger than the specified threshold are removed by screening.

8. The method of claim 1 wherein the particles larger than the specified threshold are removed by a combination of air classification and screening.

9. The method of claim 1 wherein the specified threshold is 110 microns.

10. The method of claim 1 wherein the specified threshold is 100 microns.

11. The method of claim 1 wherein the specified threshold is 90 microns.

12. The method of claim 1 wherein the specified threshold is 80 microns.

13. The method of claim 1 wherein the specified threshold is 70 microns.

14. The method of claim 1 wherein the specified threshold is 60 microns.

15. The method of claim 1 wherein the specified threshold is 50 microns.

16. The method of claim 1 wherein the specified threshold is 40 microns.

17. The method of claim 1 wherein the specified threshold is 30 microns.

18. The method of claim 1 wherein the specified threshold is 20 microns.

19. The method of claim 1 including using a metal trap to passivate Nickel and Vanadium.

20. The method of claim 1 wherein the hydrocarbon conversion process depends on particle size for reaction rate or yields.

21. The method of claim 2 wherein the spray-dried catalyst composition is a fresh composition.

22. The method of claim 2 wherein the spray-dried catalyst composition is an equilibrium composition.

23. The method of claim 2 wherein the spray-dried catalyst composition is a combination of fresh catalyst and equilibrium catalyst.

24. The method of claim 2 wherein the particles larger than the specified threshold are removed by air classification.

25. The method of claim 2 wherein the particles larger than the specified threshold are removed by screening.

26. The method of claim 2 wherein the particles larger than the specified threshold are removed by a combination of air classification and screening.

27. The method of claim 2 wherein the specified threshold is 110 microns.

28. The method of claim 2 wherein the specified threshold is 100 microns.

29. The method of claim 2 wherein the specified threshold is 90 microns.

30. The method of claim 2 wherein the specified threshold is 80 microns.

31. The method of claim 2 wherein the specified threshold is 70 microns.

32. The method of claim 2 wherein the specified threshold is 60 microns.

33. The method of claim 2 wherein the specified threshold is 50 microns.

34. The method of claim 2 wherein the specified threshold is 40 microns.

35. The method of claim 2 wherein the specified threshold is 30 microns.

36. The method of claim 2 wherein the specified threshold is 20 microns.

37. The method of claim 2 including using a metal trap to passivate Nickel and Vanadium.

38. The method of claim 2 wherein the hydrocarbon conversion process depends on particle size for reaction rate or yields.

39. A composite catalyst composition for use in any hydrocarbon conversion process that is dependent on the particle size.

40. The composite catalyst of claim 39 formed by the blending of two or more components with different compositions and different particle size distribution.

41. The composite catalyst of claim 39 wherein at least one of the components contains a limitation on the particle size.

42. The composite catalyst of claim 39 wherein no more than 5% of the particles are larger than 110 microns and no more than 5% of the particles are smaller than 20 microns.

43. The composite catalyst of claim 39 wherein one of the components contains ZSM-5 or other MFI zeolite.

44. The composite catalyst of claim 39 wherein the components may be separated into two or more fractions with different chemical compositions for possible reuse.

45. A composite catalyst composition formulated for a specific hydrocarbon conversion process by size distribution.

46. The composite catalyst of claim 45 with a high amount of matrix activity and a standard FCC catalyst for bottoms conversion.

47. The composite catalyst of claim 45 for use with bottoms conversion having a low zeolite to matrix composition with more than 95% of its particles less than 80 microns and up to 50% of a ZSM-5 additive with optimized particle size distribution.
